(19) United States
(12) Patent Application Publication
(10) Pub. No.: US 2026/0273589 A1
(43) Pub. Date: Sep. 17, 2026

(54) MAGNETIC CHIP REMOVAL SYSTEM

(71) Applicant: Team Industrial Services, Inc., Sugar Land, TX (US)

(72) Inventors: Brian Michael GRESH, Sugar Land, TX (US); David Benjamin ALDREN, Sugar Land, TX (US); Matthew GUEST, Sugar Land, TX (US); Chris CROWELL, Sugar Land, TX (US); Brian TIDWELL, Sugar Land, TX (US); Glenn R. PETERS, Sugar Land, TX (US)

(21) Appl. No.: 19/668,293

(22) Filed: May 5, 2026

Related U.S. Application Data
(63) Continuation of application No. 18/029,184, filed on Oct. 13, 2021, now abandoned.
(60) Provisional application No. 63/092,804, filed on Oct. 16, 2020.

(51) Int. Cl. B08B 9/027

(52) U.S. Cl. CPC B08B 9/027

(57) ABSTRACT

A technique which facilitates cleaning of an interior of a pipe via access through a lateral hole in the pipe. The technique utilizes a control bar head which may be coupled with a control bar via a coupling feature. A shroud is positioned around the control bar head. The shroud may have a suitable shape with an interior sized to enable linear movement of the control bar head along the interior between an extended position and a retracted position. Additionally, the shroud has an exterior sized to enable insertion through the lateral hole in the pipe. Magnets may be coupled with the control bar head and oriented to pick up particles in the pipe when the control bar head is located in the extended position, and enable retrievable of the particles when the system is withdrawn.

### CROSS-REFERENCE TO RELATED APPLICATION

This Application is a Continuation of Application 18/029,184 filed on Oct. 13, 2021. Application PCT/US2021/054774 claims the benefit of U.S. Provisional Application 63/092,804 filed on Oct. 16, 2020, which is incorporated herein by reference in its entirety.

### FIELD OF DISCLOSURE

In general, the disclosure describes a pipe cleaning system which may be inserted through a lateral hole in a pipe within a vessel carrying pressurized gas or liquid. The pipe cleaning system utilizes a control bar head with attached magnets to facilitate attraction and retrieval of particles from the pipe. The control bar head may be shifted between positions within a shroud to prevent the particles from being knocked off and contaminating the inside of the vessel and/or related components. The magnets may be encased by a flexible or rigid cover which is not removed until the device is disassembled from the vessel and which aids with the removal and disposal of the particles.

### BACKGROUND OF DISCLOSURE

When performing pipeline maintenance or servicing, such as during hot tapping procedures, it is necessary to tap through a side wall of the pipe to enable isolation of a section of the pipe. However, the process of tapping through the side wall of the pipe can create metal particles which fall to the lower side of the pipe. Such particles can be problematic if not removed from the pipe. For example, the particles can affect the ability of a pipe isolation device to create suitable seals between the pipe isolation device and the surrounding interior wall of the pipe.

What is needed is a pipe cleaning device which can easily be inserted through a tapped hole in a sidewall of the pipe and which can then be operated to retrieve the unwanted particles from the interior of the pipe.

### SUMMARY

This summary is provided to introduce a selection of concepts that are further described below in the detailed description. However, many modifications are possible without materially departing from the teachings of this disclosure. Accordingly, such modifications are intended to be included within the scope of this disclosure as defined in the claims. This summary is not intended to identify key or essential features of the claimed subject matter, nor is it intended to be used as an aid in limiting the scope of the claimed subject matter.

According to an embodiment, a system and methodology are provided to facilitate cleaning of an interior of a pipe via access through a lateral hole in the pipe. The technique utilizes a pipe cleaning tool having a control bar head which may be coupled with a control bar via a coupling feature. A shroud is positioned around the control bar head. The shroud may have a suitable shape with an interior sized to enable linear movement of the control bar head along the interior between an extended position, e.g. a lower position, and a retracted position. Additionally, the shroud has an exterior sized to enable insertion through the lateral hole in the pipe. Magnets may be coupled with the control bar head and oriented to pick up particles in the pipe when the control bar head is located in the lower position. When the control bar head is shifted to the retracted position, the magnets ensure retrieval of the particles into the shroud for removal from the pipe when the system is withdrawn. The shroud minimizes the risk of the particles falling off the magnets and contaminating the interior of components, e.g. a valve, through which the pipe cleaning tool travels to and from the interior of the pipe.

### BRIEF DESCRIPTION OF THE FIGURES

Certain embodiments of the disclosure will hereafter be described with reference to the accompanying drawings, wherein like reference numerals denote like elements. It is emphasized that, in accordance with standard practice in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein, and:

FIG. 1 is an illustration of an example of a pipe cleaning device inserted through a lateral hole in a pipe and configured in a retracted position in accordance with embodiments of the present disclosure;

FIG. 2 is an illustration of the pipe cleaning device illustrated in FIG. 1 but with the pipe cleaning device configured in an extended position, e.g. a lower position, to attract particles from a bottom side of the pipe in accordance with embodiments of the present disclosure;

FIG. 3 is a side view of an example of a pipe cleaning device in accordance with embodiments of the present disclosure;

FIG. 4 is a cross-sectional view of an example of a pipe cleaning device in accordance with embodiments of the present disclosure; and

FIG. 5 is a bottom view of an example of a pipe cleaning device in accordance with embodiments of the present disclosure.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms "up" and "down"; "upper" and "lower"; "top" and "bottom"; and other like terms indicating relative positions to a given point or element are utilized to more clearly describe some elements.

The present disclosure generally relates to a system and methodology for cleaning an interior of a pipe via access through a lateral hole in the pipe. The pipe may comprise a variety of pipes used in industrial applications or other applications. When a section of the pipe is serviced or replaced, a pipe isolation device may be inserted into the interior of the pipe through a lateral hole cut through a sidewall of the pipe. However, cutting the lateral hole can create particles, e.g. shavings, which fall into the interior of the pipe. In a variety of applications, the pipe may be generally horizontal and the particles fall to a lower interior side of the pipe where they can interfere with the pipe isolation device.

Accordingly, the present pipe cleaning technique may be used to remove those particles prior to insertion of the pipe isolation device. The cleaning technique utilizes a pipe cleaning tool/device having a control bar head which may be coupled with a control bar via a coupling feature. A shroud is positioned around the control bar head. The shroud may have a suitable shape with an interior sized to enable linear movement of the control bar head along the interior between a retracted position and an extended position, e.g. a lower position. Movement of the control bar head and control bar may be controlled by a variety of actuators, e.g. hydraulic actuators, electrical actuators, mechanical actuators, or other suitable actuators. For example, the actuator may be the same or similar to those used for inserting and withdrawing pipe isolation devices.

Additionally, the shroud has an exterior sized to enable insertion through the lateral hole in the pipe. A magnet or magnets may be coupled with the control bar head and oriented to pick up particles in the pipe when the control bar head is located in the extended/lower position of the shroud so as to place the magnet(s) proximate the lower interior side of the pipe. Furthermore, the magnets may be encased by a rigid or flexible cover. As a result, the magnet(s) attract the particles resting along the lower interior of the pipe, and the particles collect onto the outside of the magnet(s) or onto the outside of the rigid or flexible cover located over the magnet(s). When the control bar head is shifted to the retracted position, the magnets ensure retrieval of the particles into the shroud for removal from the pipe when the system is withdrawn. Pulling the particles into the shroud can provide a variety of benefits including prevention of component contamination, e.g. prevention of contamination of a fitting branch and valve. Effectively, the shroud helps ensure that particles collected by the magnets do not become dislodged and caught up in valve seats or other equipment. By positioning the shroud around the control bar head, the particles attracted by the magnets are guarded against unwanted release and this prevents their subsequent movement into valve sealing locations or other mating equipment. After the pipe cleaning device is removed from the pipe and associated assembly, the shroud is pulled back to gain access to the particles. At this point, the magnet cover may be removed along with the particles. Pulling the cover away from the magnets breaks the magnetic attraction which simplifies discard of the particles and cleanup of the device. In other embodiments without the magnet cover, the particles may be removed, e.g. wiped away, from the magnets after removal of the pipe cleaning device.

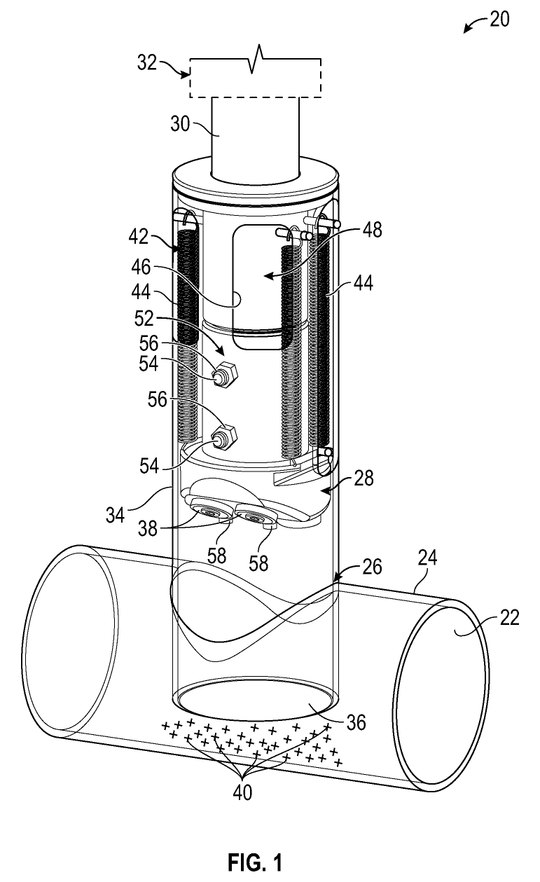

Referring generally to FIG. 1, an embodiment of a pipe cleaning system 20, e.g. a pipe cleaning tool/device, is illustrated as inserted into an interior 22 of a pipe 24 via a lateral hole 26 formed, e.g. tapped/cut, through the sidewall of the pipe 24. According to the illustrated embodiment, the pipe cleaning system 20 comprises a control bar head 28 which may be connected to a control bar 30. The control bar 30 may be part of or may be coupled with an actuator 32, e.g. a hydraulic actuator, which may be controlled to shift the control bar 30, and thus the control bar head 28, back and forth linearly.

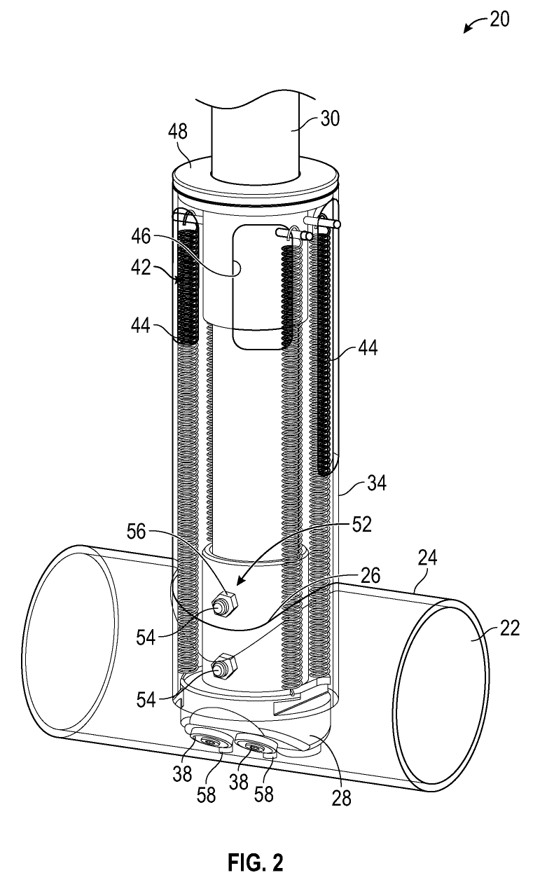

As illustrated, the pipe cleaning system 20 further comprises a shroud 34 which may be in the form of a cylindrical barrel or have other suitable shapes. The shroud 34 has an interior 36 which is sized to enable linear movement of the control bar head 28 back and forth between a retracted position (see FIG. 1) and a lower or extended position (see FIG. 2). Additionally, the shroud 34 has an exterior sized to enable insertion through lateral hole 26 formed in pipe 24. For example, the exterior of the shroud 34 may have a diameter slightly smaller than the diameter of lateral hole 26.

According to the illustrated embodiment, the pipe cleaning system 20 further comprises at least one magnet 38, e.g. a plurality of magnets 38, connected to control bar head 28. The magnets 38 are oriented to pick up particles 40, e.g. metal shavings, resulting from the cutting of lateral hole 26 and which often collect along a lower interior of pipe 24. As the control bar head 28 and magnets 38 are shifted from the retracted position to the lower or extended position, the magnets 38 are moved into proximity with particles 40 (see FIG. 2). The magnets 38 are able to attract and retain the particles 40 when the magnets 38 are moved to this proximate location. Once the particles 40 are collected via magnets 38, the control bar head 28 and magnets 38 may be shifted back along the interior of shroud 34 to the retracted position (see FIG. 1). The pipe cleaning system 20 along with particles 40 may then be withdrawn from pipe 24 via control bar 30.

The magnets 38 may be positioned along a lower side of control bar head 28 in an arrangement which places them into the desired proximity with particles 40. Depending on the application, the size and type of magnets 38 may vary. For example, magnets 38 may be permanent magnets. However, the magnets 38 also may be in the form of electromagnets which are selectively powered via a battery or other electrical power source. The use of electromagnets enables selective activation of magnets 38 after, for example, they are moved into the interior of pipe 24. In some embodiments, the shroud 34 also may be constructed with an internal flapper or other type of closure device which automatically closes off the lower portion of the shroud 34 once the magnets 38 and attached particles 40 have been withdrawn to the retracted position.

With additional reference to FIG. 3, the pipe cleaning system 20 may comprise a variety of other features and components. For example, the pipe cleaning system 20 may comprise a spring member 42 positioned to bias the control bar head 28 to the retracted position within the shroud 34. Various types of spring members 42 may be employed, but one example utilizes spring member 42 in the form of a plurality of extension springs 44 connected between attachment features on the control bar head 28 and the interior of shroud 34. As the control bar head 28 is shifted to the lower/extended position, the extension springs 44 stretch and establish a spring bias back toward the retracted position. As illustrated, the shroud 34 may have various openings 46 providing access to springs 44 or other internal features of pipe cleaning system 20.

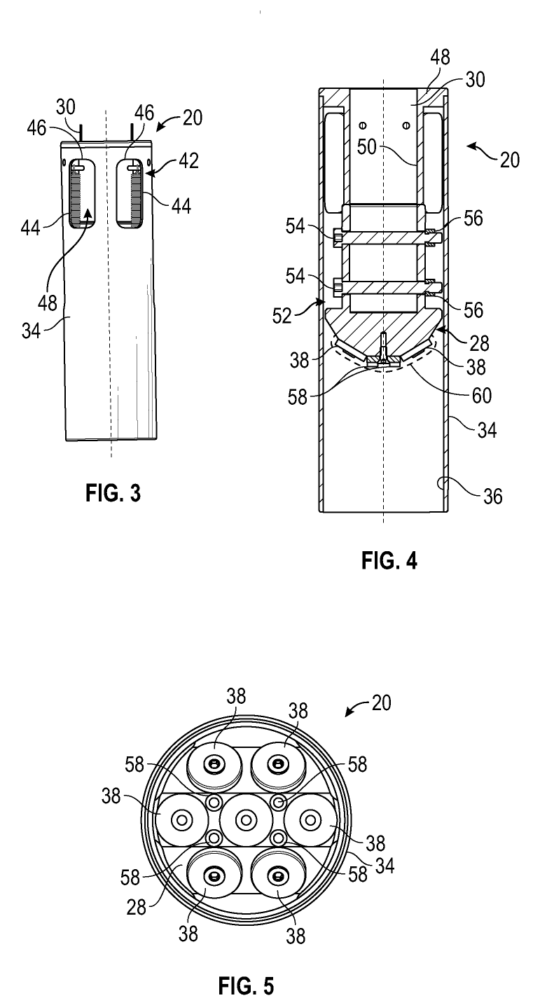

As further illustrated in FIG. 4, the pipe cleaning system 20 also may comprise a support structure 48 which is welded or otherwise secured within shroud 34. The support structure 48 has an interior passage 50 sized to facilitate sliding movement of the control bar 30 within shroud 34. In this example, the control bar head 28 is connected to the control bar 30 via a coupling feature 52. The coupling feature 52 may have a variety of configurations and is designed to secure the control bar head 28 to the control bar 30 as the pipe cleaning system 20 is transitioned between lower and retracted positions. By way of example, the coupling feature 52 may comprise one or more bolts 54 extending through the control bar head 28 and control bar 30 and secured in place with corresponding nuts 56, e.g. locknuts.

With additional reference to FIG. 5, the control bar head 28 may comprise one or more abutments 58. By way of example, the abutments 58 may be in the form of shims secured to control bar head 28 via appropriate screws. The abutments 58 may be sized to extend beyond the magnets 38 so as to bottom out against the lower interior surface of pipe 24 without letting the magnets 38 contact the interior of pipe 24. In some embodiments, the magnets 38 may be formed of relatively fragile, e.g. brittle, material and the abutments 58 protect the magnets 38 from damage when the control bar head 28 and control bar 30 are shifted to the lower/extended position.

It should be noted that a variety of particle retention mechanisms 60 may be used to aid with the release of the particles 40 from the pipe cleaning system 20 when the particles 40 need to be removed from the magnets 38 (see FIG. 4). For example, the particle retention mechanism 60 may be in the form of a metal cover or other type of cover which provides a surface onto which particles 40 can collect during their removal from the interior of pipe 24. When the cover is removed from magnets 38, the particles 40 which are collected along the outside surface of the cover break their magnetic attraction to the magnets 38. According to one embodiment, the particle retention mechanism 60 may be in the form of a particle retention sack formed of a flexible material which can be used to entirely cover or at least partially cover the magnets 38 and control bar head 28. The particle retention mechanism 60 is sized to fit within the shroud 34 while fully or partially covering the magnets 38 and control bar head 28. This aids in removal of the particles from the magnets 38 and helps with discard of the particles 40 as well as cleanup of the pipe cleaning system 20.

Depending on the parameters of a given pipe cleaning operation, however, the configuration and use of overall pipe cleaning system 20 may be adjusted. For example, various types of actuators 32 may be used to transition the pipe cleaning system 20 between operational positions and to withdraw system 20 from pipe 24. Additionally, the number, type, and arrangement of magnets 38 may be selected according to the type of particulates to be removed and on the environment in which pipe cleaning system 20 is employed. The shroud 34 and spring member 42 may have a variety of sizes and configurations selected according to the specifics of the pipe cleaning operation. Various additional and/or other components and features also may be incorporated into the overall pipe cleaning system 20.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. The scope of the invention should be determined only by the language of the claims that follow. The term "comprising" within the claims is intended to mean "including at least" such that the recited listing of elements in a claim are an open group. The terms "a," "an" and other singular terms are intended to include the plural forms thereof unless specifically excluded.

What is claimed is:

1. A system for cleaning an interior of a pipe via access through a lateral hole in the pipe, the system comprising:
a pipe cleaning system having:
a control bar head having a coupling feature for coupling with a control bar;
a shroud positioned around the control bar head, the shroud having an interior sized to enable linear movement of the control bar head along the interior between a lower position and a retracted position, the shroud having an exterior sized to enable insertion through the lateral hole in the pipe; and
a plurality of magnets coupled with the control bar head and oriented to pick up particles in the pipe when the control bar head is located in the lower position and then to retrieve the particles into the shroud when the control bar head is shifted to the retracted position to guard against release of the particles.

2. The system as recited in claim 1, further comprising a spring positioned to bias the control bar head to the retracted position within the shroud.

3. The system as recited in claim 1, wherein the plurality of magnets comprises permanent magnets.

4. The system as recited in claim 1, wherein the plurality of magnets comprises electromagnets.

5. The system as recited in claim 1, wherein the coupling feature comprises a plurality of bolts extending between the control bar head and the control bar.

6. The system as recited in claim 1, further comprising abutments secured to the control bar head to serve as stops when the control bar head is inserted into the pipe.

7. The system as recited in claim 1, further comprising a removable cover which encases the plurality of magnets and serves to aid with removal of the particles from the pipe cleaning system.

8. A method for cleaning an interior of a pipe via access through a lateral hole in the pipe, the method comprising:
coupling a control bar head with a control bar;
positioning a shroud around the control bar head, the shroud having an interior sized to enable linear movement of the control bar head along the interior between a retracted position and an extended position, the shroud having an exterior sized to enable insertion through the lateral hole in the pipe; and
mounting at least one magnet to an end of the control bar head and orienting the at least one magnet to pick up particles in the pipe when the control bar head is located in the extended position and then to retrieve the particles into the shroud when the control bar head is shifted to the retracted position.

9. The method as recited in claim 8, wherein mounting the at least one magnet to the end of the control bar head comprises mounting the at least one magnet to a lower end of the control bar head.

10. The method as recited in claim 9, wherein mounting the at least one magnet comprises mounting a plurality of magnets.

11. The method as recited in claim 8, further comprising using a particle retention mechanism over the at least one magnet to aid with particle release when the particle retention mechanism is removed from the at least one magnet.

12. The method as recited in claim 11, wherein using the particle retention mechanism comprises using a particle retention sack.

13. The method as recited in claim 11, wherein using the particle retention mechanism comprises using a removable cover.

14. The method as recited in claim 8, further comprising spring biasing the control bar head toward the retracted position.

15. The method as recited in claim 8, wherein mounting the at least one magnet comprises mounting at least one permanent magnet.

16. The method as recited in claim 8, wherein mounting the at least one magnet comprises mounting at least one electromagnet.

17. The method as recited in claim 8, further comprising using abutments to limit travel of the control bar head.

18. A system , comprising:
a pipe cleaning system having:
a control bar head;
a shroud positioned around the control bar head, the shroud having an interior sized to enable linear movement of the control bar head along the interior between a retracted position and an extended position, the shroud having an exterior sized to enable insertion through a lateral hole in a pipe; and
a magnet coupled with the control bar head and oriented to attract particles located in the interior of the pipe.

19. The system as recited in claim 18, wherein the pipe cleaning system further comprises a spring member oriented to bias the control bar head to the retracted position within the shroud.

20. The system as recited in claim 18, further comprising a control bar coupled between the control bar head and an actuator.
